(19) United States
(12) Patent Application Publication
(10) Pub. No.: US 2007/0087141 A1
(43) Pub. Date: Apr. 19, 2007

(54) Electromagnetic wave absorbing material and electromagnetic wave absorbing particulate

(75) Inventors: Shigeru Ogawa, Nagaoka-shi (JP); Takaichi Suzuki, Nagaoka-shi (JP)

Correspondence Address: SUGHRUE MION, PLLC, 2100 PENNSYLVANIA AVENUE, N.W., SUITE 800, WASHINGTON, DC, 20037, US

(73) Assignee: Yugen Kaisha NOC

(21) Appl. No.: 11/547,000

(22) Filed: Oct. 13, 2006

(30) Foreign Application Priority Data
Oct. 17, 2005 (JP) 2005-301914
Sep. 21, 2006 (JP) 2006-255416

(51) Int. Cl. B31B 45/00; B32B 27/08; B29C 47/00

(52) U.S. Cl. 428/34.1; 428/35.7; 428/36.9

(57) ABSTRACT

There is provided a highly innovative and exceptionally useful technique for enabling an excellent and hitherto unavailable electromagnetic wave absorbing action to be produced for preventing electromagnetic noise in a highly effective manner. An electromagnetic wave absorbing material is obtained by mixing a magnetic mixture (1) with a resin (2), wherein the mixture (1) is configured by forming a magnetic material (3) into a hollow shape (3a) having a hollow part (3a), and providing a dielectric material (4) to the hollow part (3a) of the magnetic material (3).

### BACKGROUND OF THE INVENTION

1. Field of the Invention

The present invention relates to an electromagnetic wave absorbing material and an electromagnetic wave absorbing particulate for absorbing, e.g., noise and other unnecessary electromagnetic waves produced by an electronic component included in an electronic product or the like. The materials and particulate may, for example, prevent the external leakage of noise produced by an electronic component, or, for example, protect an electronic component from external electromagnetic waves and noise.

2. Description of the Related Art

Various techniques have previously been proposed as measures for preventing disturbance from electromagnetic waves or noise produced by electronic products or other sources.

For example, an electromagnetic wave absorbing material has previously been proposed that protects an electronic product from the effects of external electromagnetic waves and noise and prevents electromagnetic waves and noise produced by an electronic component from leaking to the exterior by attenuating (cutting) electromagnetic noise using an electromagnetic wave absorbing action by a magnetic material based on ferrite, iron, chromium, cobalt, or the like.

This electromagnetic wave absorbing material has a structure whereby, for example, the magnetic material is molded into the form of a thin plate, overlaid in multiple layers with a resin or other material similarly molded as a thin plate to form a panel, and mounted as such a panel in an electronic product or electronic component. A resin or other dielectric material is stacked in multiple layers with the magnetic material in this configuration, allowing an excellent electromagnetic wave absorbing action to be exhibited and electromagnetic waves and noise to be efficiently attenuated.

However, an electromagnetic wave absorbing material of the type in which a multilayered panel is formed using a magnetic material is extremely difficult to mold because each magnetic material has a high degree of hardness, and therefore has drawbacks in terms of productivity. In addition, molding such materials into a desired shape while conforming to the configuration of the electronic product or component is extremely difficult, resulting in limited versatility. Furthermore, magnetic materials are exceedingly expensive due to being formed in multiple layers using a complex process using ferrite, metal, or the like.

Therefore, problems related to practical utility are presented insofar as electromagnetic wave absorbing materials composed of multiple layers of magnetic materials are difficult to mold, poor in terms of productivity and versatility, and costly, despite their excellent ability to absorb and attenuate electromagnetic noise.

An electromagnetic wave absorbing material composed of a magnetic mixture blended with a resin has previously been proposed; e.g., as disclosed in JP (Kokai) 2004-336028.

The material is obtained by, for example, mixing a ferrite particulate or other magnetic material with a resin and molding the magnetic mixture into, e.g., a sheet or film. The magnetic material composed of a particulate body admixed into a resin exhibits an electromagnetic wave absorbing action that attenuates electromagnetic waves and noise.

In an electromagnetic wave absorbing material of the type obtained by mixing a magnetic mixture with a resin, the resin into which the mixture has been admixed may simply be molded into a sheet or a film. Therefore, this type of electromagnetic wave absorbing material is manufactured more readily than the above-described type, which is obtained by fashioning a magnetic material or the like into the form of a multi-layered panel using a complex process, and for that reason alone offers an improvement in terms of mass productivity and cost. Accordingly, the type of electromagnetic wave absorbing material obtained by mixing a magnetic mixture with a resin is widely used to prevent disturbance from electromagnetic waves or noise produced in an electronic product or electronic component.

(Patent document 1) JP patent laid-open No. 2004-336028

### SUMMARY OF THE INVENTION

The present invention provides an extremely innovative electromagnetic wave absorbing material that was discovered at as a result of additional research and development on the type of electromagnetic wave absorbing material proposed in the prior art and obtained by mixing a magnetic mixture with a resin. The present invention provides an innovative technology having extremely high usability as described hereunder. It shall be apparent that the present invention can simply be molded into a sheet or film in the same manner as the conventional type of electromagnetic wave absorbing material obtained by mixing a magnetic mixture with a resin. An extremely favorable electromagnetic wave- and noise-absorbing action heretofore unseen in this type of electromagnetic wave absorbing material can be produced, and electromagnetic waves and noise can be attenuated even more favorably. The proportion of the mixture to be admixed with the resin whereby an exceptional electromagnetic wave- and noise-absorbing action will be obtained may also be kept low, in which case the fluidity of the resin can be increased. The material may, therefore, be more readily molded into a predetermined shape, or the material can be directly coated onto an electronic component or the like. The material can be more readily provided to a desired location in a desired style.

A summary of the present invention shall be described with reference to the accompanying drawings.

The present invention relates to an electromagnetic wave absorbing material obtained by mixing a magnetic mixture 1 with a resin 2; wherein the mixture 1 is obtained by forming a magnetic material 3 into a hollow shape having a hollow part 3a.

The present invention relates to the electromagnetic wave absorbing material according to a first aspect, wherein the mixture 1 has a configuration whereby a dielectric material 4 is provided to the hollow part 3a of the magnetic material 3 formed into a hollow shape having a hollow part 3a.

The present invention further relates to the electromagnetic wave absorbing material according to a second aspect, wherein the magnetic material 3 is formed into a shape having an opening 5 that opens into the hollow part 3a of the magnetic material 3; and is configured so that the dielectric material 4 fills into or is caused to flow into the hollow part 3a of the magnetic material 3 from the opening 5.

The present invention further relates to the electromagnetic wave absorbing material according to a third aspect, wherein the opening 5 that opens into the hollow part 3a of the magnetic material 3 is opened to such a degree that the dielectric material 4 can fill into or be caused to flow into the hollow part 3a of the magnetic material 3 via at least the opening 5; and the degree of the opening is made as small as possible.

The present invention further relates to the electromagnetic wave absorbing material according to any of the first through fourth aspects, wherein the magnetic material 3 is formed into a hollow shape having openings 5 that open into the hollow part 3a of the magnetic material 3 in at least two or more of a plurality of locations.

The present invention further relates to the electromagnetic wave absorbing material according to any of the first through fourth aspects, having a configuration obtained by mixing with the resin 2 a plurality of the mixtures 1, which have been formed into particulates having mutually differing particle diameters.

The present invention further relates to the electromagnetic wave absorbing material according to a fifth aspect, having a configuration obtained by mixing with the resin 2 a plurality of the mixtures 1, which have been formed into particulates having mutually differing particle diameters.

The present invention further relates to an electromagnetic wave absorbing particulate wherein a magnetic material 3 is formed into a hollow magnetic particulate body 3′ having a hollow part 3a; and is configured from multiple magnetic particulate bodies 3′.

The present invention further relates to the electromagnetic wave absorbing particulate according to an eighth aspect, wherein a dielectric material 4 is provided to the hollow part 3a of the hollow magnetic particulate body 3′ having a hollow part 3a.

The present invention further relates to the electromagnetic wave absorbing particulate according to a ninth aspect, wherein the hollow magnetic particulate body 3′ having a hollow part 3a is formed into a shape having an opening 5 that opens into the hollow part 3a of the magnetic particulate body 3′; and is configured so that the dielectric material 4 fills or is caused to flow into the hollow part 3a of the magnetic particulate body 3′ from the opening 5.

The present invention further relates to the electromagnetic wave absorbing particulate according to a tenth aspect, wherein the opening 5 that opens into the hollow part 3a of the magnetic particulate body 3′ is opened to such a degree that the dielectric material 4 can fill or be caused to flow into the hollow part 3a of the magnetic particulate body 3′ via at least the opening 5; and the degree of opening is made as small as possible.

The present invention further relates to the electromagnetic wave absorbing particulate according to any of the eighth through eleventh aspects, wherein the magnetic particulate body 3′ is formed into a hollow shape having openings 5 that open into the hollow part 3a in at least two or more of a plurality of locations.

The present invention further relates to the electromagnetic wave absorbing particulate according to any of the eighth through eleventh aspects, composed of a plurality of magnetic particulate bodies 3′ that are formed into particulates having mutually differing particle diameters.

The present invention further relates to the electromagnetic wave absorbing particulate according to a twelfth aspect, composed of a plurality of magnetic particulate bodies 3′ that are formed into particulates having mutually differing particle diameters.

The present invention is configured in the above-described manner and can therefore be readily formed into a variety of shapes; can readily be provided to a desired location in a desired shape in the same manner as the electromagnetic wave absorbing material in the prior-art example in which a magnetic mixture is admixed into a resin; and does not present any concerns over high costs.

Not only does the electromagnetic wave absorbing action created by the magnetic properties of the mixture that is admixed into the resin allow electromagnetic waves and noise to be absorbed and attenuated as in the example of the prior art, but the hollow magnetic material itself, prepared as a mixture, absorbs and attenuates electromagnetic waves and noise via a capacitor effect, and therefore allows even better electromagnetic wave and noise attenuating characteristics to be obtained.

In the present invention, the hollow magnetic material itself, prepared as a mixture, exhibits a capacitor effect with respect to the electromagnetic waves, and accordingly has highly favorable electromagnetic wave- and noise-attenuating characteristics that have not been achieved in conventional types of electromagnetic wave absorbing materials obtained by mixing a magnetic mixture with a resin. Moreover, the magnetic material is merely a resin into which a mixture has simply been admixed. Therefore, the magnetic material may be charged into a desired mold and readily molded into a desired shape while in an exceedingly fluid (liquid) state before the resin with which the mixture has been admixed is molded (cured), the product of the present invention may be applied to the rear surface of a cover or other part of an electronic product that produces electromagnetic noise, the product of the present invention may be applied and cured on an electronic component that is to be protected against the effects of electromagnetic waves and noise, or the product can otherwise be simply provided to the desired location in the desired style. Accordingly, extremely high value is offered in terms of practical application through the excellent electromagnetic wave and noise-absorbing effect that is exhibited, and the material can readily be produced with excellent mass productivity and at advantageous cost. For these and other reasons, the electromagnetic wave absorbing material is an extremely effective and innovative measure for preventing disturbance from electromagnetic waves and noise in electronic products, electronic components, or the like; and has extremely high commercial value.

According to the invention of the eight aspect, the magnetic particulate body exhibits an electromagnetic wave absorbing action not only based on the magnetic properties of the magnetic particulate body itself, but also by employing a capacitor effect created by the hollow shape of the magnetic particulate body. The magnetic particulate body is therefore an innovative electromagnetic wave absorbing particulate whereby extremely favorable electromagnetic wave and noise attenuating characteristics can be produced by these two actions.

Therefore, mixing the electromagnetic wave absorbing particulate with a suitable resin as, for example, a mixture that is admixed into a resin, and applying the resulting mixture to an electronic component or other part that is to be protected from the effects of electromagnetic waves and noise, will make it possible to readily obtain an excellent electromagnetic wave absorbing material that yields the same excellent effect as the above-described invention according to the first aspect. The electromagnetic wave absorbing particulate is extremely effective and innovative, and has high commercial value as a measure for preventing disturbance from electromagnetic waves and noise in electronic products, electronic components, and the like.

### BRIEF DESCRIPTION OF THE DRAWINGS

FIG. 1 is a descriptive perspective cross-sectional view of the mixture 1 of the electromagnetic wave absorbing material according to the present example;

FIG. 2 is a descriptive cross-sectional view of the electromagnetic wave absorbing material according to the present example; and

FIG. 3 is a descriptive perspective cross-sectional view showing an additional example of the mixture 1 of the electromagnetic wave absorbing material according to the present example.

### DESCRIPTION OF THE PREFERRED EMBODIMENTS

A brief description of preferred embodiments of the present invention (the manner in which the present invention is implemented) indicating the operation of the present invention shall be provided with reference to the drawings.

A magnetic mixture 1 exhibits an electromagnetic wave absorbing action based on the magnetic properties thereof; i.e., exhibits an action whereby electromagnetic waves and noise are directly absorbed and converted to heat, thereby providing electromagnetic wave and noise attenuating characteristics.

Therefore, a resin 2 admixed with the magnetic mixture 1 will have an electromagnetic wave- and noise-attenuating characteristics due to the magnetic properties of the mixture 1.

The mixture 1 is composed of a magnetic material 3. The magnetic material 3 is formed into a hollow shape that not only has magnetic properties, but also has a hollow part 3a.

For this reason, the hollow magnetic material 3 exhibits a predetermined capacitor effect that corresponds to the permittivity of the member in the hollow part 3a of the magnetic material 3 with regard to electromagnetic waves and noise in the magnetic material 3. In other words, an electromagnetic wave- and noise-absorbing action is created by the dielectric loss effect of the capacitor (e.g., a capacitor effect is favorably exhibited by providing a dielectric material 4 to the hollow part 3a of the magnetic material, and even if the hollow part 3a is empty, the magnetic material 3 will exhibit an electromagnetic wave- and noise-absorbing action because the air itself has a certain dielectric property).

The resin 2 with which the hollow magnetic material 3 (the mixture 1) is admixed accordingly has electromagnetic wave- and noise-absorbing and attenuating characteristics due to the capacitor effect of the hollow magnetic material 3.

Therefore, in the present invention, not only does the electromagnetic wave absorbing action produced by the magnetic properties of the mixture 1 that is admixed with the resin 2 allow electromagnetic waves and noise to be absorbed and attenuated, as in the example of the prior art, but electromagnetic waves and noise can also be absorbed and attenuated by the capacitor effect of the hollow magnetic material 3 itself, which is the mixture 1, yielding extremely favorable electromagnetic wave- and noise-attenuating characteristics.

In addition, because the attenuating characteristics can be correspondingly improved, favorable attenuating characteristics can be obtained even if, for example, the content of the mixture 1 (magnetic material 3) with respect to the resin 2 is reduced. The amount of ferrite or other active magnetic material used can be correspondingly reduced to reduce costs.

The interior of the hollow part 3a of the hollow magnetic material 3 may, for example, be empty (the air itself has a dielectric property). However, if a configuration is employed wherein, e.g., a dielectric material 4 that has a high dielectric property is provided, as with the resin 2 that is admixed with the mixture 1, a capacitor effect that is more effective against electromagnetic waves and electromagnetic noise in high-frequency bands will be exhibited, the high-frequency electromagnetic waves and electromagnetic noise will be more favorably absorbed, and electromagnetic waves and noise can be attenuated within a wide range of bands from low-frequency bands to high-frequency bands.

If, for example, the hollow magnetic material 3 is formed into a shape having an opening 5 that opens into the hollow part 3a of the magnetic material 3, the dielectric material 4 can readily fill or be caused to flow from the opening 5 into the hollow part 3a of the magnetic material 3. A problem is presented in that if the opening 5 of the magnetic material 3 is wide, the electromagnetic wave- and noise-absorbing action of the magnetic material 3 will inevitably decrease. However, this problem cannot occur if the opening 5 of the magnetic material 3 is opened to such a degree that the dielectric material 4 can fill or be caused to flow into the hollow part 3a of the magnetic material 3 via at least the opening 5, as well as if the opening 5 is as small as possible.

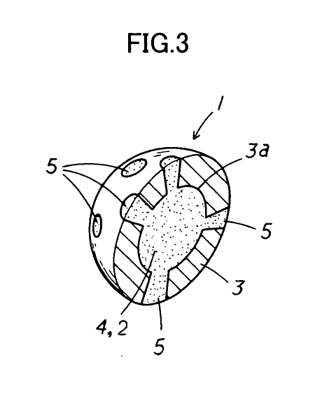

The magnetic material 3 may have a hollow shape with an opening 5 that opens into the hollow part 3a in only a single location, and may also have a hollow shape with openings 5 in multiple locations. When a shape is used in which openings 5 are present in two or more locations in this manner, the dielectric material 4 can readily fill or be caused to flow into the hollow part 3a of the magnetic material via the openings 5, even if the openings are not wide. In positions on the surface of the hollow magnetic material 3 where the openings 5 are disposed, the dielectric material 4 that fills the openings 5 is provided between parts of the magnetic material 3 that constitutes these positions on the surface, as shown in FIG. 3. In other words, the magnetic material 3 and dielectric material 4 are arranged in an alternating fashion on the surface, and a configuration can thereby be employed in which an even greater capacitor effect is produced.

If, for example, a configuration is adopted in which a plurality of the mixtures 1 formed into particulates having mutually differing particle diameters is admixed with the resin 2, the mixtures 1 that have mutually differing particle diameters will produce a capacitor effect having different resonant frequencies for each particle. Therefore, the material will have electromagnetic wave- and noise-attenuating characteristics that are extremely effective in a wide range of frequency bands (equivalent to a filter circuit to which capacitors having different resonant frequencies are connected).

Therefore, the present invention can absorb and attenuate electromagnetic waves and noise extremely well, while having the properties of a resin (the mixture is merely admixed with a resin, resulting in exceptional fluidity before the resin is cured), and can therefore be readily molded into a desired shape or be directly applied on an electronic component or the like. Accordingly, the present invention can readily be provided to the desired location in the desired style and attenuate electromagnetic waves and noise extremely well; has excellent usability; and is an extremely effective and innovative electromagnetic wave absorbing material having high commercial value as a measure for preventing disturbance from electromagnetic waves and noise in an electronic product or electronic component.

In the invention pertaining to the eighth aspect, the magnetic material 3 is an electromagnetic wave absorbing particulate, wherein wave absorbing particles having hollow parts 3 are able to exhibit extremely favorable electromagnetic wave- and noise-attenuating characteristics through an electromagnetic wave absorbing action created by the magnetic properties of the magnetic particulate body 3′ itself as well as a capacitor effect generated due to the hollow shape of the magnetic particulate body 3′.

Therefore, mixing the electromagnetic wave absorbing particulate exhibiting exceptional attenuating characteristics with a suitable resin 2 or another material so that the electromagnetic wave absorbing particulate will be contained therein will make it possible to readily obtain an innovative and commercially valuable electromagnetic wave absorbing material, which, as described hereinabove, can readily be molded into a desired shape or be directly applied on a desired location, and be capable of exhibiting an excellent electromagnetic wave- and noise-attenuating action. For these and other reasons, the electromagnetic wave absorbing particulate is of exceptional practical utility.

### EXAMPLES

A specific example of the present invention shall be described hereunder with reference to the drawings.

In the present example, in an electromagnetic wave absorbing material formed by mixing a magnetic mixture 1 with a resin 2, the mixture 1 is produced by forming a magnetic material 3 into a hollow shape having a hollow part 3a.

The hollow magnetic material 3 that constitutes the mixture 1 is produced by forming a magnetic body into a hollow shape. In the present example, ferrite is used as the magnetic body that constitutes the magnetic material 3 (mixture 1). The magnetic body is not limited to ferrite, and may also be a magnetic body based on iron, chromium, cobalt, or the like; or may be any other material that can exhibit the same function as the present example.

The hollow magnetic material 3 can also have a configuration in which a dielectric material 4 is provided to the hollow part 3a of the magnetic material 3.

The hollow magnetic material 3 is therefore able to exhibit a predetermined capacitor effect that corresponds to the permittivity of the dielectric material 4 provided to the hollow part 3a of the magnetic material 3 with respect to the emission of electromagnetic waves and noise.

The dielectric material 4 may merely be air (i.e., the hollow part 3a may be empty). However, the amount of attenuation of the magnetic material 3 increases as the permittivity of the dielectric material 4 provided to the hollow part 3a of the magnetic material 3 increases (i.e., the dielectric material 4 is effective in attenuating electromagnetic waves and noise). Therefore, the resin 2 with which the magnetic material 3 is admixed is used as the dielectric material 4 that is provided to the hollow part 3a of the magnetic material 3.

In the present example, silicone is used as the resin 2; however, this is not the only option. Any material that has a high permittivity and is highly fluid (e.g., epoxy), and that is able to exhibit the same action and effect as the present example, may be used.

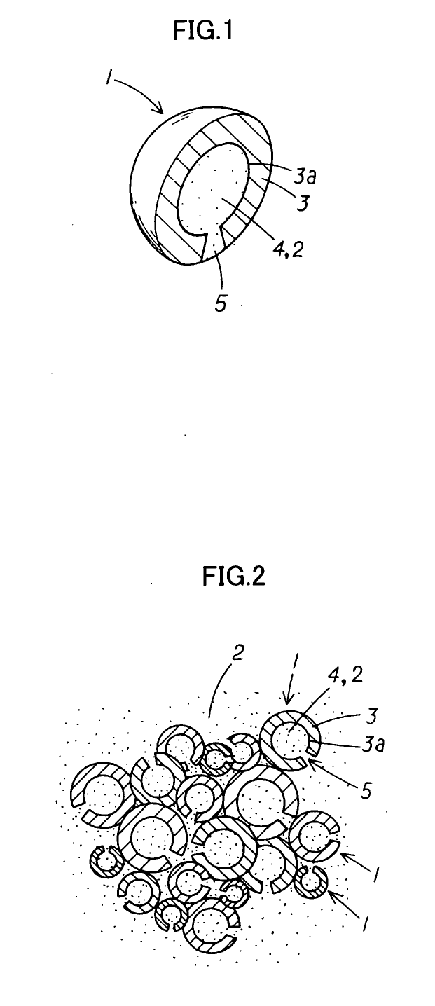

The magnetic material 3 is formed into a shape having an opening 5 that opens into the hollow part 3a of the magnetic material 3, as shown in FIG. 1.

The dielectric material 4 can therefore fill into or be caused to flow into the hollow part 3a of the magnetic material 3 via the opening 5.

The opening 5 that opens into the hollow part 3a of the magnetic material 3 is opened to such a degree that the dielectric material 4 can be provided to the hollow part 3a of the magnetic material 3 via at least the opening 5; and the area of the opening 5 is set to be at most substantially half or less of the outer surface area of the mixture 1.

In the present example, a configuration is adopted in which a plurality of mixtures 1 (magnetic materials 3) is admixed with the resin 2; and the plurality of mixtures 1 admixed with the resin 2 is imparted with non-uniform shapes having mutually different particle diameters, as shown in FIG. 2.

The magnetic materials 3 that have been admixed with the resin 2, formed into hollow shapes, and have mutually differing particle diameters are each resonant at different frequencies with respect to electromagnetic waves and noise, and therefore exhibit broadband characteristics.

Specifically, the mixtures 1 are configured by, first, mixing the hollow magnetic materials 3 having hollow parts 3a and the resin 2 (dielectric material 4) in a vacuum state, and then causing the resin 2 to flow into the hollow parts 3a of the magnetic materials 3 by ending the vacuum state.

Therefore, the influx of the dielectric material 4 (resin 2) into the hollow parts 3a of the hollow magnetic materials 3 (mixture 1) can be performed at the same time that the mixture 1 is admixed with the resin 2. As a result, the manufacture of the material is facilitated and exceptional mass productivity is achieved.

FIG. 3 shows an additional example of a hollow magnetic material 3 (mixture 1) of the electromagnetic wave absorbing material of the present example described hereinabove.

Specifically, the additional example shown in FIG. 3 represents an instance wherein the magnetic material 3 is formed into a hollow shape having openings 5 that open into a hollow part 3a of the hollow magnetic material 3 in at least two or more of a plurality of locations rather than in only one location.

When the magnetic material 3 is thus configured into a hollow shape having multiple openings 5, the dielectric material 4 can readily fill into or be caused to flow into the hollow parts 3a of the magnetic material 3 via the openings 5 even if the openings 5 are opened to a small degree. Furthermore, in positions on the surface of the hollow magnetic material 3 where the openings 5 are disposed, the dielectric material 4 that fills the openings 5 is provided between parts of the magnetic material 3 that constitutes these positions on the surface, as shown in FIG. 3. In other words, the magnetic material 3 and dielectric material 4 are arranged in an alternating fashion in positions on the surface, and a configuration can thereby be employed in which an even greater capacitor effect is exhibited.

The present invention is configured in the above-described manner. Therefore, the magnetic mixtures 1 that have been admixed with the resin 2 each exhibit an effect whereby electromagnetic waves and noise are absorbed and converted to heat by the magnetic properties of the mixtures, and the electromagnetic waves and noise are attenuated by this action.

The attenuation is achieved not only through the magnetic properties of the mixtures 1. The magnetic material 3 (mixture 1) is formed into a hollow shape, and the dielectric material 4 (resin 2) having high permittivity is provided within the hollow part 3a of the magnetic material 3. When multiple magnetic materials 3 (mixtures 1) are used, these materials each exhibit a capacitor effect, electromagnetic waves and noise are absorbed by the dielectric loss effect of the capacitor, and the electromagnetic waves and noise can be attenuated by this action.

In other words, not only are electromagnetic waves and noise attenuated by the magnetic properties of each of the mixtures 1 that have been admixed with the resin 2, but also by the capacitor effect of each of the mixtures 1. As a result, favorable attenuating characteristics can be obtained.

In addition, because the attenuating characteristics can be correspondingly improved, favorable attenuating characteristics can be obtained even if, for example, the content of the mixture 1 (magnetic material 3) with respect to the resin 2 is reduced. The amount of ferrite or other magnetic material used can be correspondingly reduced, and costs can readily be reduced.

In contrast to the example of the prior art in which a magnetic material 3 (mixture 1) composed of a ferrite particulate body or the like is merely admixed into a resin and then formed into a sheet or film, the electromagnetic wave absorbing material of the present example can attenuate electromagnetic waves and noise extremely well during use (after being cured). The resin 2 with which the mixture 1 is admixed can therefore be poured into a mold and molded to match the shape of an electronic component to which the product of the present example is to be provided. The product is obtained, e.g., by mixing the mixture 1 with the resin 2. The product is then securely mounted by being cured. The excellent electromagnetic wave- and noise-attenuating function can additionally be exhibited by providing the product of the present invention in a straightforward manner in the desired style in a variety of applications, such as applying the product of the present example to a cover of an electronic component that produces electromagnetic waves, and then curing the product to prevent external leakage of the electromagnetic noise produced by the electronic component. Moreover, the electromagnetic wave absorbing material is valuable in terms of mass productivity and cost, and for these and other reasons offers exceptional utility, and is also an extremely effective and innovative measure for preventing disturbance from electromagnetic waves and noise.

The operation of causing the resin 2 to flow into the hollow part 3a of the hollow magnetic material 3 can be performed simultaneously with the operation of mixing the resin 2 and the magnetic material 3 (mixture 1) into whose hollow part 3a the resin 2 is caused to flow. The product of the present example can thus be efficiently produced. Therefore, mass production can readily be achieved, and the electromagnetic wave absorbing material is accordingly valuable in terms of both mass productivity and cost.

In the present example, a plurality of the hollow magnetic materials 3 shown in FIG. 1 was admixed into the resin 2 as the mixture 1. A description was provided for an electromagnetic wave absorbing material composed of the resin 2 and the mixtures 1 (hollow magnetic materials 3), as shown in FIG. 2. However, the magnetic materials 3 may be configured, for example, as a hollow magnetic particulate body 3′ having a hollow part 3a, as shown in FIG. 1, and can be used as an electromagnetic wave absorbing particulate composed of a plurality of magnetic particulate bodies 3′ without being admixed with the resin 2.

In this instance, for example, the user would purchase and then mix this electromagnetic wave absorbing particulate with a resin 2 suitably selected in accordance with the application or objective. The user can thereby readily obtain the desired electromagnetic wave absorbing material, and for these and other reasons the electromagnetic wave absorbing material offers exceptional utility.

The present invention is not limited to the present example, and specific configurations having a variety of structural requirements can suitably be designed.

What is claimed is:

1. An electromagnetic wave absorbing material obtained by mixing a magnetic mixture with a resin; wherein the mixture is configured by forming the magnetic material into a hollow shape having a hollow part.

2. The material of claim 1, wherein the mixture has a configuration whereby a dielectric material is provided to the hollow part of the magnetic material formed into a hollow shape having a hollow part.

3. The material of claim 2, wherein the magnetic material is formed into a shape having an opening that opens into the hollow part of the magnetic material; and is configured so that the dielectric material fills into or is caused to flow into the hollow part of the magnetic material from the opening.

4. The material of claim 3, wherein the opening that opens into the hollow part of the magnetic material is opened to such a degree that the dielectric material can fill into or be caused to flow into the hollow part of the magnetic material via at least the opening; and the degree of the opening is made as small as possible.

5. The material of any of claims 1 through 4, wherein the magnetic material is formed into a hollow shape having openings that open into the hollow part of the magnetic material in at least two or more of a plurality of locations.

6. The material of any of claims 1 through 4, having a configuration obtained by mixing with the resin a plurality of the mixtures, which have been formed into particulates having mutually differing particle diameters.

7. The material of claim 5, having a configuration obtained by mixing with the resin a plurality of the mixtures, which have been formed into particulates having mutually differing particle diameters.

8. An electromagnetic wave absorbing particulate, wherein a magnetic material is formed into a hollow magnetic particulate body having a hollow part; and is configured from multiple magnetic particulate bodies.

9. The particulate of claim 8, wherein a dielectric material is provided to the hollow part of the hollow magnetic particulate body having a hollow part.

10. The particulate of claim 9, wherein the hollow magnetic particulate body having a hollow part is formed into a shape having an opening that opens into the hollow part of the magnetic particulate body; and is configured so that the dielectric material fills or is caused to flow into the hollow part of the magnetic particulate body from the opening.

11. The particulate of claim 10, wherein the opening that opens into the hollow part of the magnetic particulate body is opened to such a degree that the dielectric material can fill or be caused to flow into the hollow part of the magnetic particulate body via at least the opening; and the degree of opening is made as small as possible.

12. The particulate of any of claims 8 through 11, wherein the magnetic particulate body is formed into a hollow shape having openings that open into the hollow part in at least two or more of a plurality of locations.

13. The particulate of any of claims 8 through 11, composed of a plurality of magnetic particulate bodies that are formed into particulates having mutually differing particle diameters.

14. The particulate of claim 12, composed of a plurality of magnetic particulate bodies that are formed into particulates having mutually differing particle diameters.
